(19) United States
(12) Patent Application Publication
(10) Pub. No.: US 2005/0026587 A1
(43) Pub. Date: Feb. 3, 2005

(54) Radio frequency communication between devices via a power plane on a circuit board

(76) Inventor: Michael S. Miskho, Hillsboro, OR (US)

Correspondence Address: INTEL CORPORATION, P.O. BOX 5326, SANTA CLARA, CA, 95056-5326, US

(21) Appl. No.: 10/629,997

(22) Filed: Jul. 29, 2003

(51) Int. Cl. H04B 1/10; H04B 1/18

(52) U.S. Cl. 455/296; 455/283; 455/63.1

(57) ABSTRACT

A method is described for communication between devices on a circuit board using RF (radio frequency) signals. To transmit a digital signal from one device on a circuit board to another device on a circuit board, where the circuit boards may be the same or different, an appropriate carrier frequency is modulated based on the digital signal, and the modulated RF signal is then transmitted over a power plane. To receive an RF signal from a device on a circuit board, unwanted frequencies in the RF signal are filtered out; and then the RF signal is demodulated to recover a digital signal.

### FIELD

Embodiments of this invention relate to the field of communication between devices on a circuit board, and more specifically, to sending and receiving communication on a circuit board via RF (radio frequency).

### BACKGROUND

Computer platform growth trends are on a collision course. While the required number of voltage planes and communication signals on a circuit board are expanding, and the size of silicon devices on a circuit board are growing to accommodate increased capabilities of a computer, there is a desire from both a manufacturing and consumer perspective to minimize the size of the circuit board. One way to achieve this is to use power planes to facilitate radio communication between devices on modular circuit boards.

In similar fashion to how the United States Commerce Department's National Telecommunications and Information Administration (NTIA) spectrum chart depicts the radio frequency spectrum allocations to radio services operated within the United States, allocations may be defined for other environments, as well. On a modular circuit board, for example, rather than transmit digital signals over signal routes, frequency ranges may be preallocated to the modular circuit board to enable communication between devices.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a flow diagram illustrating how a device transmits digital signals to a power plane.

FIG. 2 is a flow diagram illustrating how a device receives an RF signal from a power plane.

FIG. 3 is a flowchart illustrating a method of transmitting a digital signal from a device over a power plane.

FIG. 4 is a flowchart illustrating a method of receiving an RF signal from another device over a power plane.

FIG. 5 is a block diagram illustrating a system in accordance with general embodiments of the invention.

FIG. 6 is a block diagram illustrating a system in accordance with a first embodiment of the invention.

FIG. 7 is a block diagram illustrating an exploded view of a device in accordance with the first embodiment of the invention.

FIG. 8 is a block diagram illustrating a system in accordance with a second embodiment of the invention.

FIG. 9 is a block diagram illustrating an exploded view of an RF signal converter in accordance with the second embodiment of the invention.

### DETAILED DESCRIPTION

One aspect of embodiments of the invention is a circuit board in which devices communicate via RF (radio frequency) signals. The modular circuit board may comprise a circuit board having at least one power plane; a plurality of devices, some coupled to the power plane; and at least one RF signal converter to transmit/receive and convert RF signals to and from digital signals.

Another aspect of embodiments of the invention is a method for a first device on a circuit board to communicate digital signals to a second device via a power plane. The method comprises modulating an appropriate carrier frequency based on a received digital signal into an RF signal and then transmitting the RF signal onto the power plane.

Yet another aspect of embodiments of the invention is a method for a second device on a circuit board to receive an RF signal sent from a first device signal over a power plane. The method comprises receiving an RF signal, filtering out unwanted frequencies from the RF signal, and demodulating the filtered RF signal to recover the digital signal.

Embodiments of the present invention include various operations, which will be described below. The operations associated with embodiments of the present invention may be performed by hardware devices or may be embodied in machine-executable instructions, which may be used to cause a general-purpose or special-purpose processor or logic circuits programmed with the instructions to perform the operations. Alternatively, the operations may be performed by a combination of hardware and software.

Embodiments of the present invention may be provided as a computer program product which may include a machine-readable medium having stored thereon machine-executable instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/machine-readable medium suitable for storing electronic instructions.

Moreover, embodiments of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Introduction

Using preallocated radio frequencies to regulate the sections of a radio frequency spectrum that are usable for different categories of devices coupled to power planes used for communication, it is possible to enable RF communication between devices on a circuit board by sending and receiving electrical RF waves over power planes of a printed circuit board.

“Devices”, as used herein, relate to components that may be coupled to a circuit board, and are typically silicon. For example, a device may be just a single integrated circuit, or may comprise a number of integrated circuits, such as on a microprocessor, a USB (universal serial bus) controller, or a parallel port controller. It should be understood that these are just examples of devices which may be used in embodiments of the invention, and that embodiments of the invention are not limited to the examples described.

As used herein, a circuit board may be a thin plate on which integrated circuits are placed (such as a printed circuit board), and a modular circuit board may be a board which contains the integrated circuits. A modular circuit board may comprise a motherboard, an expansion board, a daughtercard, a controller board, or a network interface card, for example.

A power plane may be a medium by which electrical power may be transferred to an electrical device. For instance, a computer motherboard may comprise one or more power planes each carrying a different voltage, such as 5V, 3.3V, 12V. A motherboard design may connect these power planes up to each silicon device according to device specifications. A power plane may be made of a copper polygon on a piece of fiberglass making up a printed circuit board. A power plane may also be made of a series of wires connected together in a way to distribute the same power plane to electrical devices.

Transmitting and Receiving Information

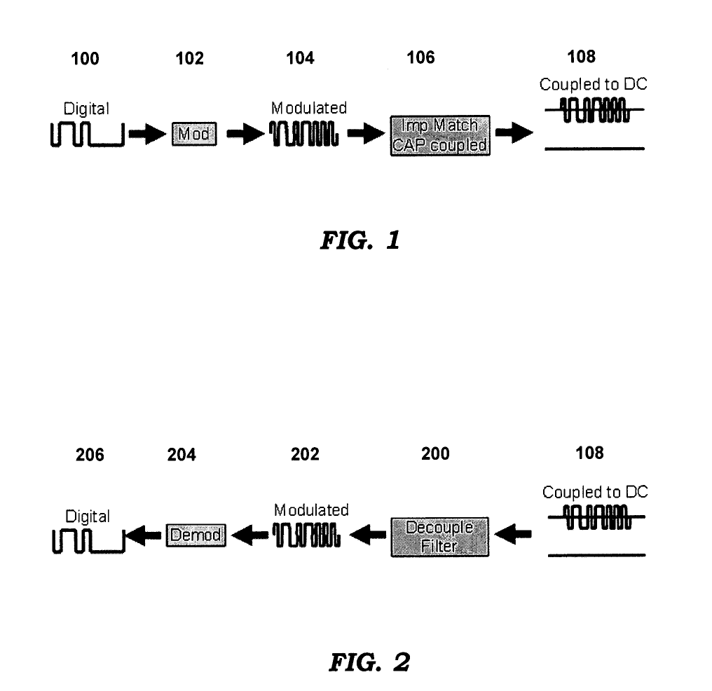

As illustrated in the flow diagram of FIG. 1, an RF signal converter processes a digital signal 100 for transmission from a sending device to a receiving device over a power plane by modulating 102 an appropriate carrier frequency based on the digital signal into an RF signal 104. The RF signal converter then transmits the modulated RF signal over the power plane by impedance matching the sending device with the power plane 106, and coupling the RF signal onto the power plane 108. In this embodiment, RF signal converter may simply be an RF transmitter for transmitting RF signals, or an RF transceiver for transmitting and receiving RF signals. As explained in more detail below, an appropriate carrier frequency as used herein may comprise a carrier frequency that is within the limits of a preallocated frequency range for a given circuit board and/or a given device.

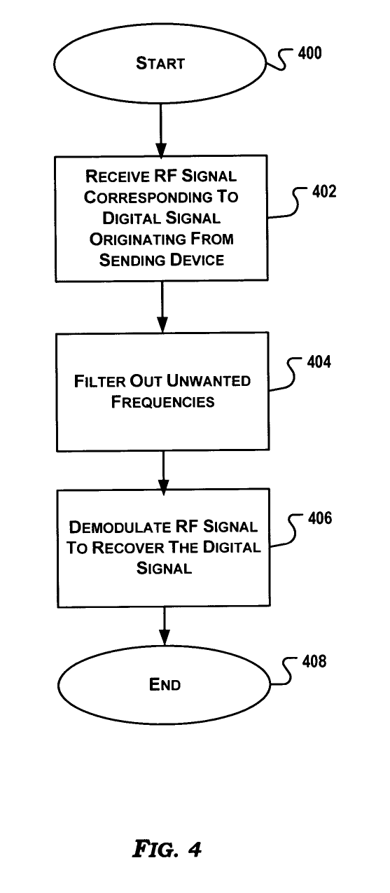

This method is illustrated in FIG. 3, which begins at block 300, and continues to block 302 where an RF signal converter modulates an appropriate carrier frequency based on a digital signal into an RF signal. At block 304, the modulated RF signal is transmitted across the power plane. The method ends at block 306.

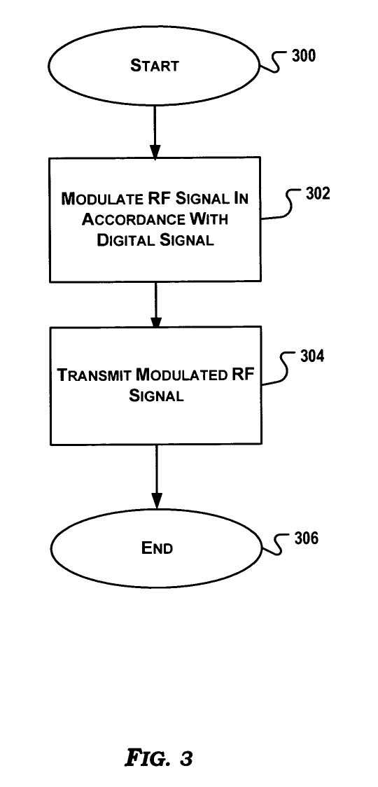

As illustrated in the flow diagram of FIG. 2, a receiving device receives an RF signal that is coupled to a power plane 108, and that corresponds to a digital signal from a sending device by impedance matching the receiving device to the power plane, and decoupling off the RF signal. Unwanted frequencies are then filtered out 200, and the resulting RF frequency is demodulated 204 to recover the digital signal 206. In this embodiment, RF signal converter may simply be an RF receiver for receiving RF signals, or an RF transceiver for transmitting and receiving RF signals.

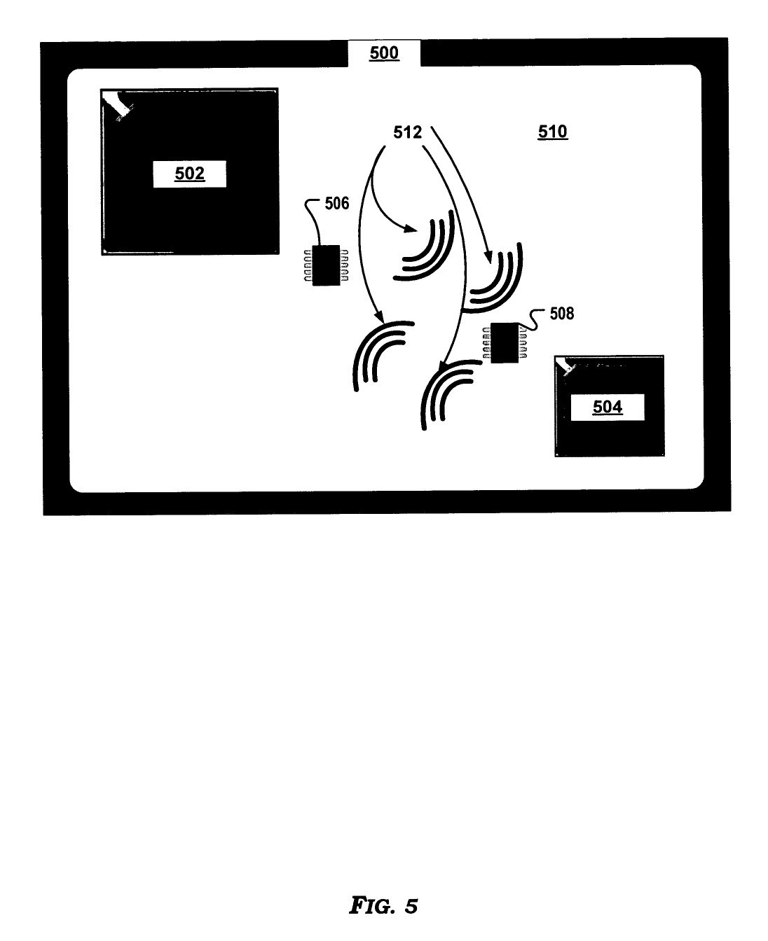

This method is illustrated in FIG. 4, which begins at block 400, and continues to block 402 where an RF signal corresponding to a digital signal originating from a sending device is received by a receiving device by impedance matching the receiving device to the power plane and decoupling the RF signal off of the power plane. At block 404, unwanted frequencies are filtered out, and at block 406, the RF signal is demodulated to recover the digital signal. The method ends at block 408.

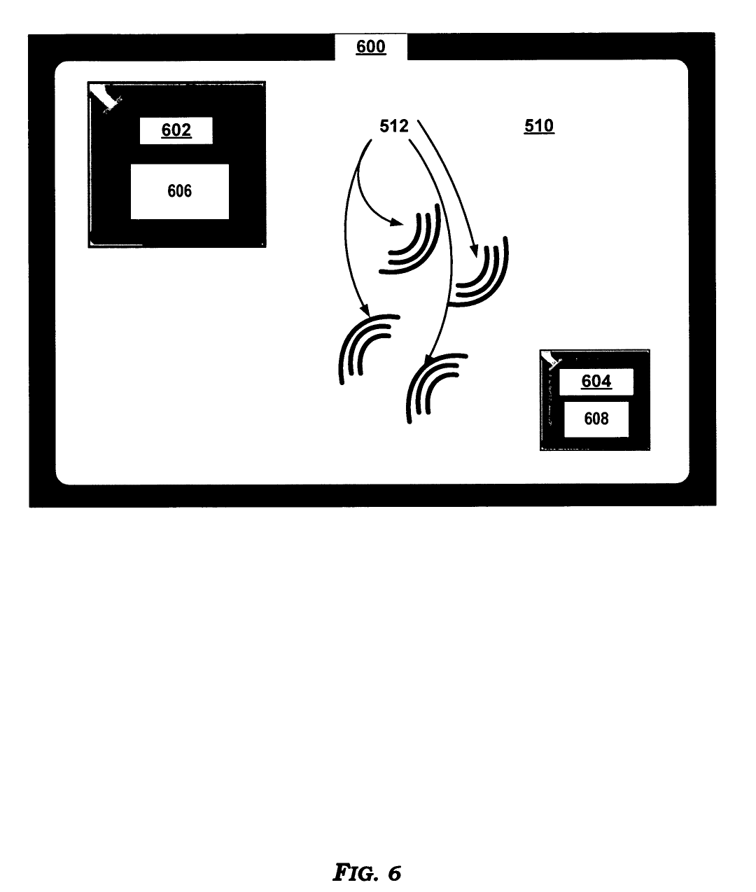

As illustrated in the block diagram of FIG. 5, a system in accordance with general embodiments of the invention comprises a circuit board 500 having at least one power plane 510 (only one shown); a plurality of devices 502, 504, where at least two are coupled to the power plane 510; and at least one RF signal converter 506, 508 (two shown) to transmit and/or receive RF signals 512 to and/or from another RF signal converter (such as 506, 508, or another one not illustrated herein) or to and/or from a device (such as 502, 504, or another one not illustrated herein). FIG. 5 does not indicate any particular relationship between devices 502, 504 and RF signal converters 506, 508.

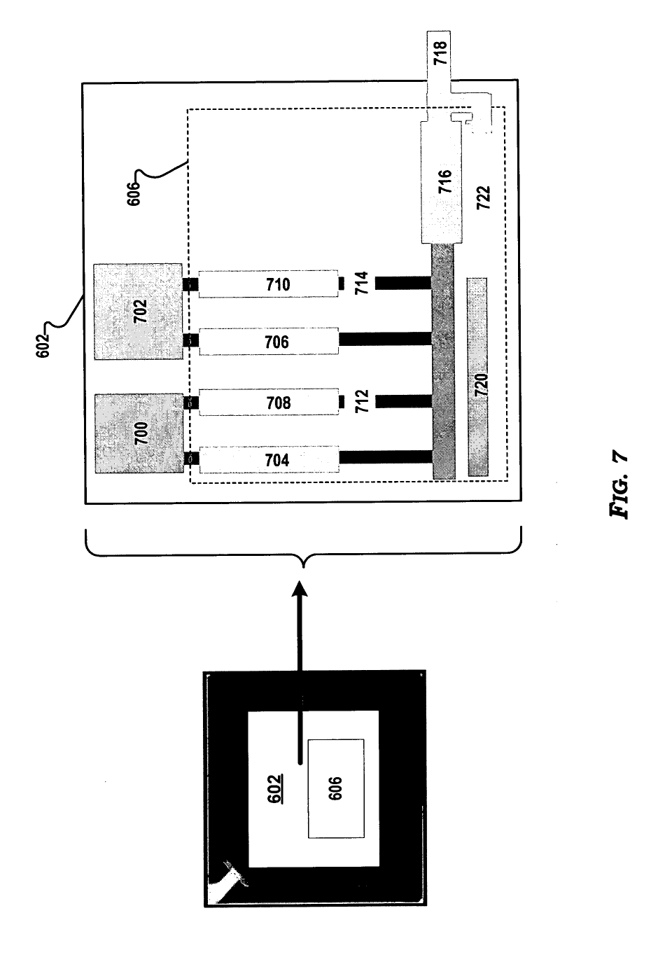

FIG. 6 is a block diagram illustrating a system in accordance with a first embodiment of the invention. The system comprises a circuit board 600 having at least one power plane 510 (only one shown); a plurality of devices 602, 604 (only two shown, may be more) where at least two are coupled to the power plane; and at least one RF signal converter 606, 608 that is internal to and embedded in device 602, 604.

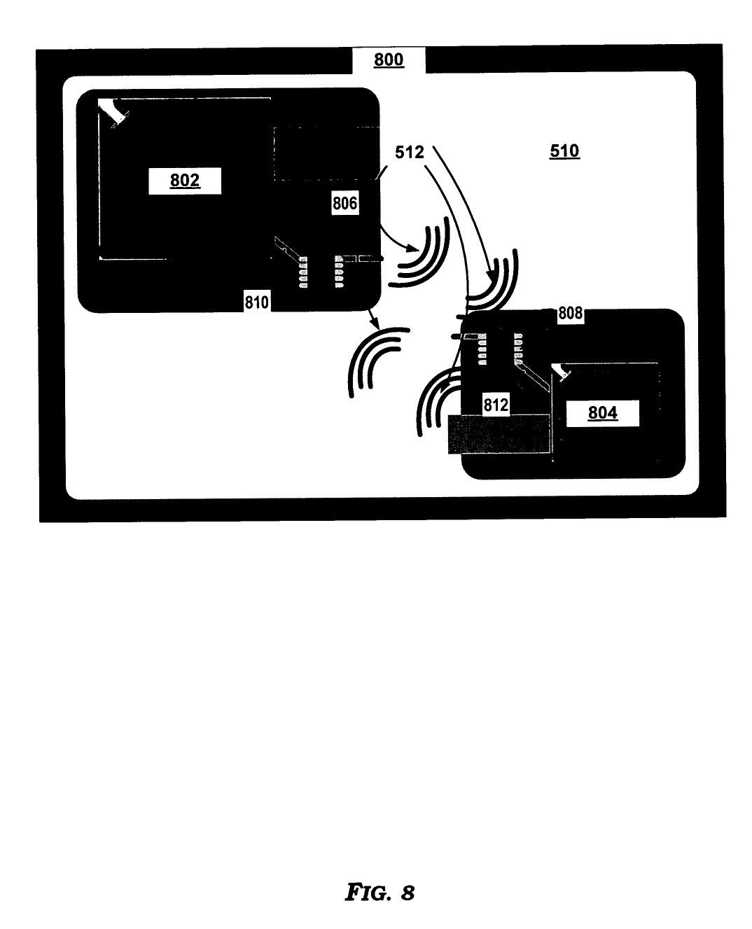

FIG. 7 illustrates an exploded view of a device such as device 602. Device 602 in this example may comprise two integrated circuits 700, 702, where RF signal converter 606 is internal to the device 602. Device 602 via RF signal converter 606 (which may be an RF transmitter or an RF transceiver), for example, may send communication to device 604 by producing a digital signal, modulating an appropriate carrier frequency based on the digital signal, and transmitting the modulated RF signal over the power plane. Device 602 via RF signal converter 606 (which may be an RF receiver or an RF transceiver), for example, may receive communication by receiving an RF signal, filtering out unwanted frequencies, and demodulating the RF signal to recover the digital signal.

In this example, RF signal converter 606 may comprise modulators 704, 706; demodulators 708, 710; filters 712, 714 coupled to each demodulator 708, 710 to filter out unwanted frequencies; a coupler/decoupler 716 to transmit the RF frequency onto a supply voltage (Vcc) 718, and then to the power plane 510, and/or receive RF frequency off supply voltage 718 from the power plane 510; a power amplifier 720 for the device 602; and a low pass filter 722 to remove high frequency RF signals from the device power well 720.

As one of ordinary skill in the art would understand, RF signal converter may comprise other components not shown herein so as to not obscure an understanding of embodiments of the invention. Thus, components such as filters coupled to the modulator, or a low noise amplifier, while typically may be part of an RF signal converter, are not shown in illustrations of embodiments of the invention.

FIG. 8 is a block diagram illustrating a system in accordance with a second embodiment of the invention. The system comprises a circuit board 800 having at least one power plane 510 (only one shown); a plurality of devices 802, 804 (only two shown, may be more), where at least two are coupled to the power plane 510, and a plurality of standalone RF signal converters 806, 808 coupled to the devices 802, 804 via signal routes 810, 812. Generally, a signal route is an electrical path on a printed circuit board that may connect two devices.

In FIG. 8, each standalone RF signal converter 806, 808 is shown to correspond to a unique device 802, 804. Alternatively, system may comprise a standalone RF signal converter to process all RF-digital signals, or a plurality of RF signal converters that do not correspond to the number of devices 802, 804, or any combination thereof.

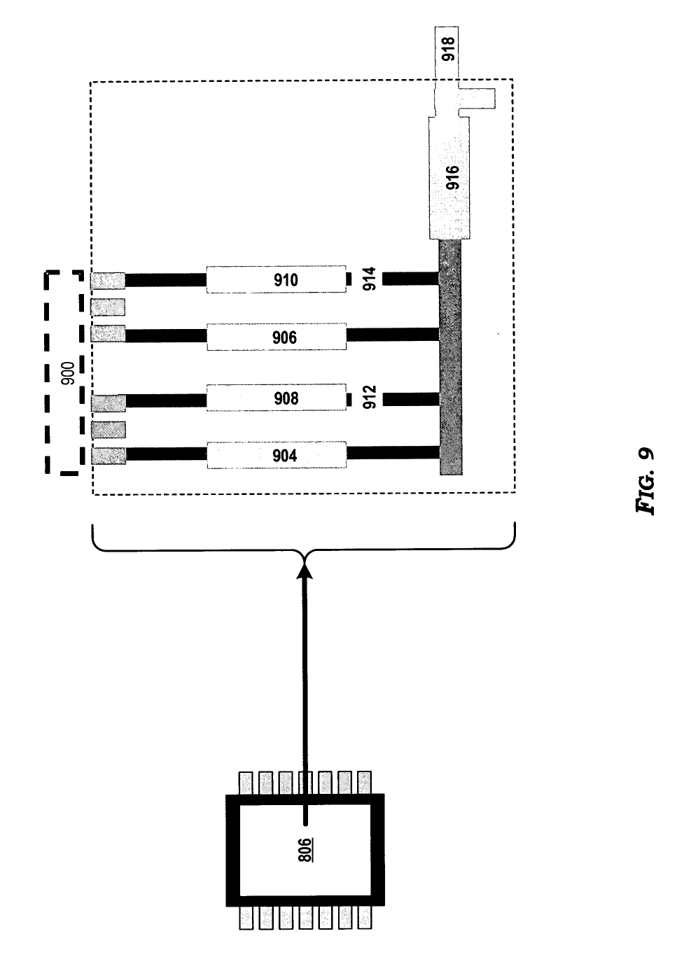

FIG. 9 illustrates an exploded view of an RF signal converter such as RF signal converter 806. RF signal converter 806 may accept digital signals 900 from device 802 via a signal route 810. RF signal converter 806 (which may be an RF transmitter or an RF transceiver) may modulate an appropriate carrier frequency based on the digital signal, and then may transmit the modulated RF signal over the power plane 510 to device 804. RF signal converter 806 (which may be an RF receiver or an RF transceiver), for example, may receive communication by receiving an RF signal, filtering out unwanted frequencies, and demodulating the RF signal to recover the original digital signal.

In this example, RF signal converter 806 comprises modulators 904, 906, demodulators 908, 910, filters 912, 914 coupled to each demodulator, and a coupler/decoupler 916 to transmit the RF frequency onto a supply voltage (Vcc) 918, and then to the power plane 510, and/or receive RF frequency off supply voltage 918 from the power plane 510.

As one of ordinary skill in the art would understand, RF signal converter may comprise other components not shown herein so as to not obscure an understanding of embodiments of the invention. Thus, components such as filters coupled to the amplifier, or low noise amplifier, while typically may be part of an RF signal converter, are not shown in illustrations of embodiments of the invention.

Furthermore, while illustrated and described embodiments may refer to communication between devices on a single circuit board, embodiments of the invention may be applied more broadly than that illustrated and described. For example, a first device on a first circuit board may communicate with a second device on a second circuit board (such as where there are layers on the circuit board) using an RF signal converter, or using an RF transmission traveling over a physical connection. Physical connections can be but are not limited to edge connectors, wires, or cables.

### RF Signal Converter

In embodiments of the invention, RF signal converter may be a transmitter, receiver, or a transceiver. Furthermore, an RF signal converter may modulate into an RF signal an appropriate carrier frequency (i.e., one that is within the limits of a preallocated frequency range for the given circuit board and/or a given device) based on a digital signal being sent from a given device.

For example, if a particular spectrum specification indicates that USB devices may only transmit signals using frequencies between and including 3.8 and 4.0 GHz, then an RF signal converter (internal, or standalone) corresponding to a USB port may modulate into RF signals a carrier frequency between 3.8 GHz and 4.0 GHz (within the limits of the preallocated frequency range) based on digital signals from the USB port. Thus, one USB port can use a frequency of 3.825 GHz to transmit RF signals, while another USB port can use a frequency of 3.925 GHz to transmit RF signals.

Furthermore, RF signal converter may demodulate a received RF signal into a digital signal in order to recover the digital signal that corresponds to the originally modulated carrier frequency.

### Filtering

When a device receives an RF signal, it filters out unwanted frequencies by filtering out those frequencies that are out of the range of preallocated frequencies specified for communication between devices on the modular circuit board. For example, if a particular spectrum specification specifies that communications between devices are to occur at 2 GHz (gigahertz) and above, then frequencies below 2 GHz are treated as noise and filtered out.

### CONCLUSION

Therefore, a method and system have been described for devices on a modular circuit board to communicate with one another using digital signals modulated within carrier frequencies into RF signals at preallocated frequency ranges over a power plane. By communicating via RF over power planes, communication connections between devices on the printed circuit board may be removed, thereby allowing the voltage planes to increase in size allowing a more steady noise free delivery of electrical power to the devices. Total pin count may decrease on the devices since dedicated pins are no longer needed for all signals. Furthermore, the required layers of a circuit board may be reduced since signal routing layers may not always be needed.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

For instance, while embodiments described and illustrated herein have been discussed with reference to a single circuit board, it should be understood by one of ordinary skill in the art that the invention may have broader application than that described and illustrated. For instance, in appropriate situations, devices on a first circuit board may communicate with devices on a second circuit board.

Furthermore, it is contemplated that embodiments of the invention may use a combination of communicating via RF signals over a power plane and digital signals over signal routes.

Of course, these examples are not exhaustive of the different possibilities that may exist for embodiments of the invention.

1. A method comprising:
receiving an RF (radio frequency) signal over a power plane of a circuit board, the RF signal corresponding to a digital signal;
filtering out unwanted frequencies in the RF signal; and
demodulating the filtered RF signal to recover the digital signal.

2. The method of claim 1, wherein the digital signal is generated from a first device, the corresponding RF signal is received on a second device, and the first and the second devices are both coupled to the first circuit board.

3. The method of claim 1, wherein said filtering out the unwanted frequencies comprises filtering out a range of frequencies that is out of a range of a preallocated frequency range for communication between devices on the circuit board.

4. The method of claim 3, wherein said filtering out the unwanted frequencies additionally comprises filtering out a range of frequencies that is out of a range of a preallocated frequency range for a device producing the digital signal.

5. A method comprising:
generating a digital signal at a first device on a circuit board having at least one power plane, the digital signal to be sent to a second device;
modulating an RF (radio frequency) signal based upon the digital signal; and
transmitting the modulated RF signal using one of the at least one power planes.

6. The method of claim 5, wherein the RF signal is modulated based on the digital signal in accordance within a preallocated frequency range for the circuit board.

7. The method of claim 6, wherein the RF signal is modulated based on the digital signal in accordance with a preallocated frequency range for the first device.

8. The method of claim 5, additionally comprising:
receiving the RF signal at the second device;
filtering out unwanted frequencies in the RF signal; and
demodulating the filtered RF signal to recover the digital signal.

9. The method of claim 8, wherein the first device is on the first circuit board.

10. The method of claim 8, wherein said filtering out the unwanted frequencies comprises filtering out a range of frequencies that is out of a range of a preallocated frequency range for communication between devices on the circuit board.

11. The method of claim 10, wherein said filtering out the unwanted frequencies additionally comprises filtering out a range of frequencies that is out of a range of a preallocated frequency range for a device producing the digital signal.

12. A system comprising:
a first circuit board having at least one first power plane;
a plurality of devices, some of which are coupled to the first circuit board, and some of which are coupled to one of the at least one first power planes;
at least one RF signal transmitter coupled to some of the plurality of devices, the RF signal transmitter capable of modulating an RF signal based on a digital signal in accordance with a range of preallocated frequencies in a radio frequency spectrum.

13. The system of claim 12, wherein one of the at least one RF signal transmitters is integrated into one of the plurality of RF devices.

14. The system of claim 12, wherein some of the at least one RF signal transmitters additionally modulates RF signals in accordance with a range of preallocated frequencies for a device producing the digital signal.

15. The system of claim 12, wherein at least two of the plurality of devices communicate via signal routes.

16. The system of claim 12, additionally comprising a second circuit board having at least one second power plane, and others of the plurality of devices are coupled to the second circuit board, and some of which are coupled to one of the at least one second power planes.

17. The system of claim 16, wherein a sending device coupled to the first circuit board transmits signals to a receiving device coupled to the second circuit board using at least one of the RF signal transmitters.

18. The system of claim 12, additionally comprising an RF signal receiver coupled to some of the plurality of devices, the RF signal receiver capable of demodulating an RF signal to recover the digital signal.

19. The system of claim 18, wherein the RF signal transmitter and the RF signal receiver are integrated into a single component.
